(19) United States
(12) Patent Application Publication
(10) Pub. No.: US 2005/0194058 A1
(43) Pub. Date: Sep. 8, 2005

(54) Suction tube for inflated objects

(76) Inventor: Daniel Hanchett, San Diego, CA (US)

Correspondence Address: DON E. ERICKSON;LAW OFFICE, 7668 EL CAMINO REAL STE. 104 #627, CARLSBAD, CA, 92009, US

(21) Appl. No.: 10/790,897

(22) Filed: Mar. 2, 2004

(51) Int. Cl. B67C 3/00

(52) U.S. Cl. 141/7

(57) ABSTRACT

An apparatus and a method for removing air from a collapsible plastic structure having known characteristics of flexibility and curvature. The apparatus is a hollow cylindrical plastic tubing having interior and exterior surfaces, the interior surface defining a flow path for a fluid. The exterior surface of the tubing is formed to have a selected number of ridges defining valleys there between, the ridges extending for a selected length of tubing. A plurality of perforations are formed in the valleys, and extended a selected length of tubing for providing a plurality of additional flow paths to the interior of the tubing.

### BACKGROUND OF THE INVENTION

1. Field of the Invention

This invention relates to a suction tube to be used with a blower/fan assembly. More particularly, the present invention relates to a Suction tube adapted for use in deflating a flexible body.

2. Background of the Invention

Currently there exists a market of inflatable structures that may be used for a variety of applications. Exemplar of these are the inflatable trampoline, or bounce, type structures used as children's entertainment. Such structures typically consist of an inflatable base or flooring section of varying thickness, sides, which may also be inflatable, and, in some cases, a roof section. Typically 18-ounce vinyl coated fabric is used, i.e, meaning that the material weighs approximately 18 ounce per square yard of fabric. A typical bounce apparatus can have up to 300 square yards or more of fabric. The structures are usually inflated by means of a fan or blower that injects air through a vent, or valve, in the base or flooring section of the structure. When a sealed structure is inflated, the air is maintained in the structure by means of plugging the vent or capping the valve. In other similar structures, where the fabric is sewn creating seams, the needle holes made during sewing create a flow path for air to continuously escape, and when the seams are not sealed, the fan is operated continuously to keep the apparatus inflated the whole time it is in use.

These structures are typically erected at playgrounds, fairs, amusement parks, and other similar venues, and are erected as temporary structures for the duration of an event. At the end of the event, the structure is deflated, packed up, and either moved to another site, or stored for use at another time. The current practice of deflating the structure consists merely of unplugging the vent, or uncapping the valve, and relying on the weight of the structure to collapse the structure under gravitational pull, and force the air from the structure through the vent. This method of deflation can be time consuming based on the size of the structure. Deflation can be speeded up by initiating the folding, or rolling up, of the structure to mechanically force the air from the structure.

The present invention describes a method and apparatus for deflating such structures that significantly reduces the time for deflating and packing such structures. The means of deflating the inflatable structure includes employment of suction tubing. Prior art is replete in the use of suction tubing for a variety of applications. Prior art tubing typically is at least semi-rigid, and capable of being sealed at both ends of the tubing, without the opportunity of air intrusion into the tubing except at the distal ends, in other words, holes in the body section of the suction tubing typically results a loss of suction, or a degradation in the operation of the tubing. However, such typical suction tubing is not efficient for use in the removal of air from an inflatable flexible structure. Inflatable flexible structures are typically constructed of a vinyl material that tends to form about the intake of the suction tubing, thereby blocking, partially or completely, the flow of air from the structure. The only way to continue deflating the structure with such tubing is to continually re-position the intake of the suction tubing to another location in the structure. However, this is also time consuming, and does not result in an efficient extraction of air from the structure since it is usually necessary to remove the suction pressure from the tubing in order to relocate it within the structure.

The present invention overcomes these limitations and provides an apparatus and method for efficiently deflating an inflatable structure by means of a specially formed suction tube.

### SUMMARY OF THE INVENTION

The present invention describes an apparatus and method of deflating inflatable structures. The method consists of attaching a specially designed suction tubing to a blower/fan, inserting the suction tubing in the vent, or valve of the structure, and operating the blower/fan in a manner to create suction, thereby removing the air from the structure.

### BRIEF DESCRIPTION OF THE DRAWINGS

FIG. 1 is a perspective view of an inflated, flexible vinyl structure showing the suction tubing of the invented inserted therein.

FIG. 2 is a perspective view of the flexible vinyl structure after the air has been removed from the structure.

FIG. 3 shows a perspective view of the preferred embodiment of the suction tubing of the invention.

FIG. 4 shows a cross-sectional view of the tubing of FIG. 3.

FIG. 5 shows a perspective view of the second exemplary embodiment of the suction tubing of the invention.

FIG. 6 shows a cross-sectional view of the tubing of FIG. 5.

FIG. 7 is a front cross-sectional view of means for perforating the tubing.

### DETAILED DESCRIPTION OF THE PREFERRED EMBODIMENTS

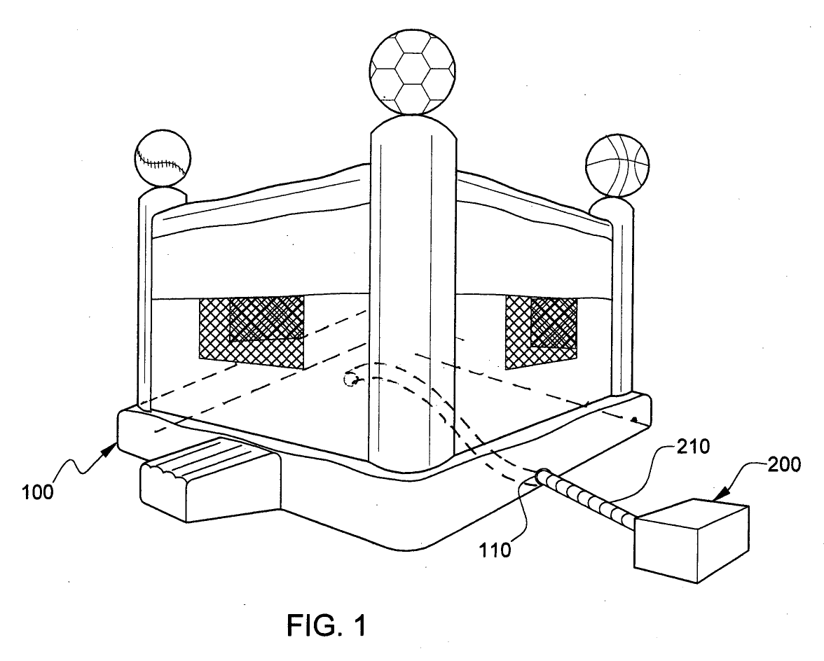

Referring now to the drawings, FIG. 1 describes a perspective, cutaway view of an inflatable structure 100, fully inflated, with the apparatus of the invention. At the base of structure 100 is air vent 110, for the receipt and removal of air from blower 200. Upon inflation of the structure, escape of the air within the structure is blocked by any conventional means, not shown, known to those of ordinary skill in the art, such means comprising a plug, cap, valve, or other equivalent means. Vent means 110 of structure 100 is not an element of the invention. It is only described for the purposes of understanding the use of the invention described herein. Also shown in FIG. 1 is suction tubing 210 extending through vent 110 and inserted a selected distance into base area 120 of structure 100. As shown in FIG. 1, suction tubing is placed to extend a substantial distance across the floor of base area 120.

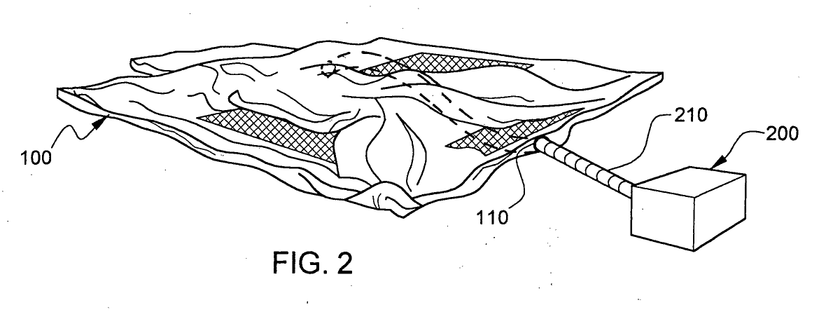

FIG. 2 describes a perspective view of structure 100 after deflation, with suction tubing 210 extending through vent 110.

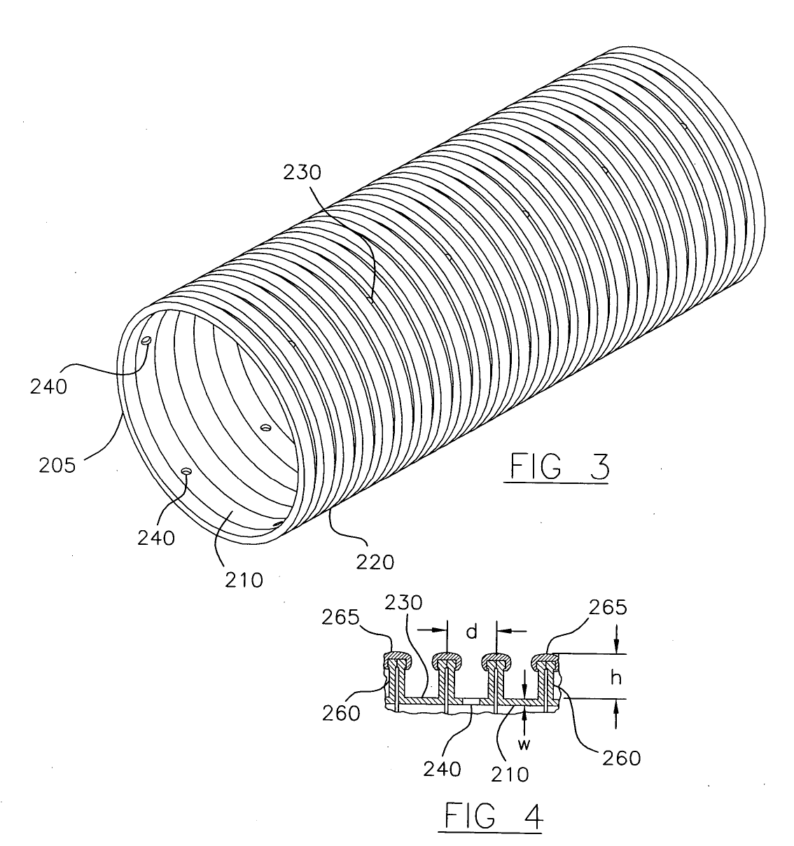

FIG. 3 discloses a perspective view of suction tubing 210, comprising a hollow elongated cylinder particularly adapted to convey fluids, which in this exemplary embodiment would be air, the tubing having a circular intake orifice 205. Extending a selected length of tubing 210 are ridges 220 disposed circumferentially along the length of the tubing, said ridges creating valleys, shown as surface 30, therebetween. Disbursed radially about tubing 210, on surface 230, medially between ridges 220 are perforations 240, providing a flow path for a fluid, such as air, between surface 230 and the interior of tubing 210. Thus, when orifice 205 is blocked, or partially blocked, the suction pressures will pull air through the perforations 240 and from structure 100, permitting continued withdrawal of air from structure 100. FIG. 4 discloses a cross-sectional segment of tubing 210 providing a plan view of the ridges 220 and the surface 230 of the tubing. The selection of the distance d between ridges 220, and the height h are important in the determining the physical parameters of tubing 210. As can be appreciated by one of ordinary skill in the art, in addition to a proper selection of distance d, it is also important to select the appropriate thickness t and height h of ridges 220 to ensure that the material of structure 100 do not abut through holes 240 to prevent the removal of air.

Referring specifically to FIG. 4, in this exemplary embodiment tubing 210 is comprised of an extruded, u-shaped vinyl commonly referred to as webbing, and which in this application is referred to as web 250, having a bottom side 255 and two parallel sides 260, which web 250 is spirally wound to form a cylinder, having tow abutting sides 255. Cap 265 is also extruded and u-shaped, having a top side 270 and two parallel sides 275, sized to matingly bind the two abutting sides 260 of web 250 to strengthen the cylinder, and when mated, web 250 and cap 265 combine to form tubing 210 having and interior 215 providing a flow path for a fluid. Experimentation has shown that for 18 ounce vinyls of the type used for structure 100, an optimum distance d between ridges is about 0.155 inches, with a ridge height h of the combined sides 260 and cap 265 of about 0.25 inches. The thickness of the bottom side 255 is about 0.040 inches. The process for manufacturing the spirally formed tubing 210 is known to those of ordinary skill in the art and is not a limitation of the invention claimed herein. Further, one of ordinary skill in the art, upon selection of the different vinyl material for apparatus 100, would know that the dimensions of d, h and t need be varied based on the flexibility and curvature characteristics of the vinyl. Thus, a more flexible vinyl may require that the distance d between adjacent ridges be less.

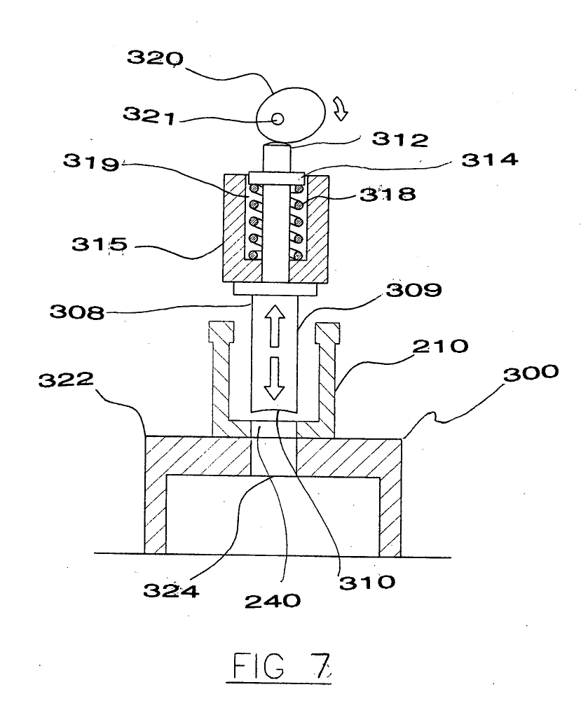

FIG. 7 is a cross-sectional view of a typical apparatus 300 for placing perforations 240 in tubing 210. In this preferred embodiment, the holes are punched in web 250 before the step of bindingly mating cap 265 with web 250 during the manufacturing process of tubing 210. Apparatus 300 consists of a pair of bushings, spring retention bushing 315, and die bushing 322, a bias means 318, punch 308, and asymmetrical cam 320 mounted on shaft 321, which shaft 321 is rotated by an electrical motor (not shown). Spring retention bushing 315 is formed to include a cylindrical cavity 319, for receiving bias means 318 and for housing punch 308, the cylindrical cavity 319 being symmetrical about its longitudinal axis.

Punch 308 is cylindrical, having a punch die cutting edge 310 at one end and a cam-following end 312 at the distal end. Intermediate punch 308 is punch flange 309, which functions to restrict the longitudinal travel of punch 308 in the direction of the upward arrow. Horizontally spaced between flange 309 and cam-following end 312 is spring retention flange 314, also fixedly attached to punch 308. Spring retention flange 314 serves to retain bias means 318 within cylindrical cavity 319. Punch 308 is symmetrical about its longitudinal axis, and when mounted in apparatus 300, it is in axial alignment with cylindrical cavity 319.

Die bushing 322 has a circular orifice 324 in axial alignment with the longitudinal axis of cylindrical cavity 319 and punch 308, the circular orifice 324 sized to complementarily receive punch die cutting edge 310. Thus the location of aperture 324 is fixed in relation to punch 308. Die bushing 322 has upper surface 327 for receiving web 250.

When apparatus 300 is assembled, punch cam-following end 312 is positioned against the surface of cam 320, with spring retention flange 314 maintaining bias means 3 18 within cylindrical cavity 319. Punch die cutting edge 3 10 is positioned over circular orifice 324 of die bushing 322, and punch flange 309 is biased against the bottom surface 305 of bushing 315 by bias means 318. Thus, when shaft 321 is rotated, punch 308, being biased against asymmetrical cam 320 by bias means 318, is driven in a linear direction shown by the arrows to mate with die 322, and thereby perforating web 250.

In this embodiment bias means 318 is a helical coil, or spring, which compresses when punch die body 309 is influenced down by cam 320, with the forces of compression maintaining cam-following end 312 of punch 308 firmly against cam 320. However, bias means 318 could also be a leaf spring, or other equivalent biasing means known by one of ordinary skill in the art.

Perforations 240 are punched into tubing 210 at selected locations along tubing 210 in the following manner. As web 250 is indexed through apparatus 300, punch 309 is positioned over a selected location along 250. Cam 320 rotates about shaft 321 in a fixed relationship to the speed that web 250 is indexed through apparatus 300. As the asymmetrical cam 320 drives punch 308 to its furthest extended linear position, punch die body 309 punches a peforation hole in web 250. Thusly, perforations 240 are punched in tubing 210 at selected distances. Web 250 is then fed through apparatus which mates cap 265 to the abutting sides 255 of web 250. In this manner, a channel for airflow is provided along the selected length of tubing 210 even when structure 100 collapses about tubing 210 during deflation. In this exemplary embodiment, the diameter of perforations 240 is about 0.037 inches. The method of perforating tubing 210 is not a limitation on the invention, but is described solely to show one means by which tubing 210 may be perforated.

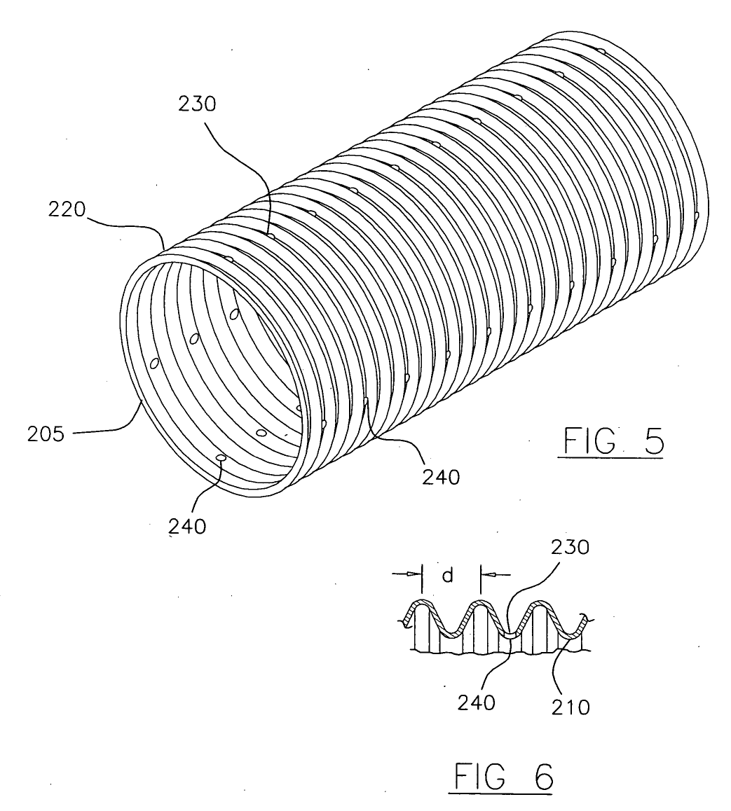

FIGS. 5 and 6 describe a second exemplary embodiment whereby the suction tubing is formed by a different process than the tubing of FIG. 3. Tubing 410 is produced by blow molding. Blow molding is a method of forming hollow articles out of thermoplastic materials whereby a molten tube of thermoplastic material is blown up with the use of compressed air to conform to the interior of a chilled blow mold. In this example, the interior of the chilled blow mold is made to conform with the desired shape of tubing 410. The mold would include elements that would provide perforations in the finished tubing. Thus tubing 410 would be removed from the mold with perforation holes 440 having been formed in the mold. FIG. 6 discloses a cross-sectional segment of tubing 410 providing a plan view of the ridges 420 and the surface 430 of the tubing with perforation holes 440. It can be readily seen the contour of the tube of FIG. 6 is smooth, however both the tubings of FIG. 3 and FIG. 5 will provide the same result as long as the dimensions of d, h and t are selected relative to the selected vinyl for apparatus 100. The process of blow molding is well know to those of ordinary skill in the art. It should be appreciated that the mold may be constructed so that ridges 420 are spiral along the length of tubing 410, or ridges 420 may be circumferential to the longitudinal axis of tubing 410 and parallel. It should also be apparent to one of ordinary skill in the art that the profile of the orifice of the tubing need not be circular, and that said profile may also be rectangular, the tubing then resembling a duct, having two sets of opposing, parallel sides. In such case, it may be desirable to perforate the tubing on all four sides for a selected length of the tube for the most optimum removal of air from the apparatus.

It should be noted that the method of blow molding the tubing of the invention has some limitations not present in the extrusion method. In the blow molding process, the length of the tubing is restricted to the length of the mold, however, with the extrusion method, the tubing may be manufactured of any selected length.

As noted above, many apparatus require that blower 200 be operated continuously due to leakage at the seams of the apparatus. When it is then desired to deflate the apparatus, it is only necessary to reverse the operation of blower 200 to suction air from the apparatus.

While the present description contains much specificity, this should not be construed as limitations on the scope of the invention, but rather as exemplifications of one/some preferred embodiment/s thereof. Accordingly, the scope of the invention should not be determined by the specific embodiments illustrated herein. The full scope of the invention is further illustrated by the claims appended hereto.

1. Suction tubing for removing air from a collapsible structure having known characteristics of flexibility and curvature, the tubing comprising:
a. a length of hollow plastic tubing having interior and exterior surfaces, the interior surface defining a flow path for a fluid;
b. the exterior surface having a plurality of adjacent ridges defining valleys there between, each ridge having a selected height, each ridge having an apex and wherein there is a selected distance between apexes of the adjacent ridges, the ridges extending a for a selected length of the tubing;
c. the valleys between the ridges contain a plurality of perforations extending a selected length of the tubing, the plurality of perforations for providing a plurality of additional flow paths to the interior of the tubing; and
wherein the height of the ridge and the distance between adjacent apexes is selected based on the characteristics of flexibility and curvature of the structure.

2. The suction tubing of claim 1 wherein the collapsible structure is plastic, and wherein the radius of curvature of the plastic is greater than the distance between adjacent ridges.

3. The suction tubing of claim 1 wherein the collapsible structure is plastic, and wherein when suction is applied to the structure the radius of curvature of the plastic is greater than the height of the ridge.

4. The suction tubing of claim 1 wherein the tubing is comprised of first and second extrusions of plastic, the first extrusion having a cross-section shape in the form of a U with first and second horizontal parallel arms and a flat bottom surface, the second extrusion having a cross-section shape of an inverted U, with two horizontal parallel gripping arms and a curved upper surface, and wherein when the first extrusion is spirally wound, the second parallel arm of one spiral abuts the adjacent first parallel arm of the next spiral, so that when the second extrusion is complementarily mated with the spirally wound first extrusion, the gripping arms of the second extrusion bind the adjacent abutting arms of the first extrusion so as to form a cylinder and the curved upper surface of the second extrusion forms the apex of the ridge.

5. The suction tubing of claim 4 wherein the first extrusion is selectedly perforated prior to the mating of the second extrusion to the spirally wound first extrusion.

6. The suction tubing of claim 5 wherein the perforations are placed at selected distances along the first extrusion.

7. The suction tubing of claim 6 wherein the distance between perforations is selected so that, when the first extrusion is spirally wound to form a cylinder, the perforations are placed circumferentially equidistant about each successive spiral.

8. The suction tubing of claim 1 wherein wherby the suction tubing is formed by a blow molding process, wherein a molten tube of thermoplastic material is blown up using compressed air to cause said material to conform to the interior of a chilled blow mold, the chilled blow mold formed to conform to the shape of the suction tubing, the blow mold having pins to produce perforations in the tubing, and wherein when the tubing is produced by the process, the tubing has said ridges, valleys, and perforations.

9. The suction tubing of claim 8 wherein the collapsible structure is plastic, having known characteristics of flexibility and curvature, wherein each of the selected ridges has an apex and wherein the distance between adjacent ridges is selected such that when suction is applied to the structure the radius of curvature of the plastic is greater than the distance between adjacent ridges.

10. The suction tubing of claim 8 wherein the collapsible structure is plastic, having a known characteristics of flexibility and curvature, wherein the each of the selected ridges has an apex, and wherein the distance from the surface of the valleys to the apex of the ridges is selected such that when suction is applied to the structure, the radius of curvature of the plastic is greater than the distance from the surface of the valley to the apex.

11. The suction tubing of claim 8 wherein the tubing is cylindrical and the perforations are placed equidistant about the circumference of the tubing.

12. The suction tubing of claim 8 wherein the tubing has a rectangular cross-section, the tubing having two pair of opposing parallel sides, and where the perforations are placed in at least two sides.

13. Suction tubing for removing air from a collapsible plastic structure having known characteristics of flexibility and curvature, the tubing comprising:
a. a length of hollow cylindrical plastic tubing having interior and exterior surfaces, the interior surface defining a flow path for a fluid;
b. the exterior surface having a plurality of adjacent ridges defining valleys there between, each ridge having a selected height, each ridge having an apex and wherein there is a selected distance between apexes of the adjacent ridges, the ridges extending for a selected length of the tubing;
c. the valleys between the ridges contain a plurality of perforations extending a selected length of the tubing, the plurality of perforations for providing a plurality of additional flow paths to the interior of the tubing, the perforations placed equidistant about the circumference of the tubing; and
wherein the distance between adjacent ridges is selected such that when suction is applied to the structure, the radius of curvature of the plastic is greater than the distance between adjacent ridges.

14. The tubing of claim 13 wherein the height of the ridge is selected such that when suction is applied to the structure the radius of curvature of the plastic is greater than the height of the ridge.

15. The suction tubing of claim 13 wherein the tubing is comprised of first and second extrusions of plastic, the first extrusion having a cross-section shape in the form of a U with first and second horizontal parallel arms and a flat bottom surface, the second extrusion having a cross-section shape of an inverted U, with two horizontal parallel gripping arms and a curved upper surface, and wherein when the first extrusion is spirally wound, the second parallel arm of one spiral abuts the adjacent first parallel arm of the next spiral, so that when the second extrusion is complementarily mated with the spirally wound first extrusion, the gripping arms of the second extrusion bind the adjacent abutting arms of the first extrusion so as to form a cylinder and the curved upper surface of the second extrusion forms the apex of the ridge.

16. The Suction tubing of claim 15 wherein the first extrusion is selectedly perforated prior to the mating of the second extrusion to the spirally wound first extrusion.

17. The suction tubing of claim 13 wherein whereby the suction tubing is formed by a blow molding process, wherein a molten tube of thermoplastic material is blown up using compressed air to cause said material to conform to the interior of a chilled blow mold, the chilled blow mold formed to conform to the shape of the suction tubing, the blow mold having pins to produce perorations in the tubing, and wherein when the tubing is produced by the process, the tubing has said ridges, valleys, and perforations.

18. The suction tubing of claim 17 wherein the distance from the surface of the valleys to the apex of the ridges is selected such that when suction is applied to the structure, the radius of curvature of the plastic is greater than the distance from the surface of the valley to the apex.

19. A method of removing air from a collapsible structure having known characteristics of flexibility and curvature, the method comprising the steps of.
a. inserting a hollow plastic tube into the collapsible structure, the tube having interior and exterior surfaces, the interior surface defining a flow path for a fluid; wherein the exterior surface of the tube has a plurality of adjacent ridges defining valleys there between, each ridge having a selected height, each ridge having an apex and wherein there is a selected distance between apexes of the adjacent ridges and wherein the height of the ridge and the distance between adjacent apexes is selected based on the characteristics of flexibility and curvature of the structure, the ridges extending for a selected length of the tubing, the valleys between the ridges contain a plurality of perforations extending a selected length of the tubing, the plurality of perforations for providing a plurality of additional flow paths to the interior of the tubing; and
b. imparting suction action to the tube.

20. The method of claim 19 wherein the collapsible structure is plastic, having known characteristics of flexibility and curvature, wherein each of the selected ridges has an apex and wherein the distance between adjacent ridges is selected such that when suction is applied to the structure the radius of curvature of the plastic is greater than the distance between adjacent ridges.

21. The method of claim 19 wherein the collapsible structure is plastic, having a known characteristics of flexibility and curvature, wherein the each of the selected ridges has an apex, and wherein the distance from the surface of the valleys to the apex of the ridges is selected such that when suction is applied to the structure the radius of curvature of the plastic is greater than the distance from the surface of the valley to the apex.

22. The method of claim 19 wherein the tube is cylindrical and the perforations are placed equidistant about the circumference of the tubing.

23. The method of claim 19 wherein the tube has a rectangular cross-section, the tube having two pair of opposing parallel sides, and the perforations are placed in at least two opposing sides.

24. The method of claim 19 wherein the means for imparting the Suction action to the tube is a blower.
